(19) United States
(12) Patent Application Publication
(10) Pub. No.: US 2010/0132951 A1
(43) Pub. Date: Jun. 3, 2010

(54) Controlled De-functionalization of Filtercakes and Other Downhole Compositions

(75) Inventors: Mohammed Hossaini, Houston, TX (US); Jeffrey McKennis, The Woodlands, TX (US); Tom Carter, Houston, TX (US)

Correspondence Address: D'AMBROSIO & MENON, LLP, 10260 WESTHEIMER, SUITE 465, HOUSTON, TX, 77042, US

(73) Assignee: TETRA Technologies, Inc., The Woodlands, TX (US)

(21) Appl. No.: 12/625,972

(22) Filed: Nov. 25, 2009

Related U.S. Application Data
(63) Continuation-in-part of application No. 11/303,109, filed on Dec. 16, 2005, now abandoned.

(51) Int. Cl. C09K 8/52; E21B 37/00; E21B 37/08; C09K 8/528; C09K 8/524

(52) U.S. Cl. 166/312

(57) ABSTRACT

A method for the controlled de-functionalization of downhole polymers comprising contacting downhole, water-dispersible, polymeric material with a dehydrating agent until the water-dispersible polymeric material is sufficiently de-functionalized to be removed. The water-dispersible polymeric material can be found in the downhole formation of a filtercake on production walls, other downhole polysaccharide materials and in fluid loss pills. The contact between the dehydrating agent and the polymeric material is prolonged until the water-dispersible, polymeric material is sufficiently de-functionalized to allow the de-functionalized material to be removed by flushing the drilling fluid. The dehydrating agent is selected from concentrated inorganic salt solutions, concentrated organic salt solutions, acid anhydrides, esters, alcohols, ethers, ketones, aldehydes, amides, organic acids and mixtures thereof.

### CROSS REFERENCES TO RELATED CASES

This application claims priority to and benefit from U.S. Provisional Patent Application Ser. No. 60/276,172 filed Dec. 21, 2004, and is a continuation in part of U.S. patent application Ser. No. 11/303,109 filed Dec. 16, 2005, incorporated by reference herein in its entirety.

### FIELD OF THE INVENTION

The present invention relates to a method for the controlled de-functionalization of filtercakes and other downhole compositions. In one embodiment, the present invention relates to a method of de-functionalization of a water-dispersible polymer, such as used in the formation of filtercakes, by contacting the polymer with a dehydrating agent.

### BACKGROUND

During the drilling of oil and gas wells, care must be taken to prevent the loss of formation fluids prior to the production stage of operations. Filtercakes are tough, almost water insoluble coatings that reduce the permeability of formation walls. The function of low-permeability filtercakes is used to seal the walls of an oil and gas formation that are exposed by the drilling process. The layer of filtercake limits losses of drilling fluid from the wellbore and protects the natural formation from any possible damage caused by drilling fluids permeating into the pores within the formation walls. A filtercake is created by the deposition of solids in the drilling fluid onto the walls of the formation rock, thereby sealing the pores. However, because the filtercake does not permanently plug the pores, it may be removed at a later time when production is desired. When drilling is complete, these filtercakes must be removed from the hydrocarbon-bearing formation so that the formation wall is restored to its natural permeability to allow for hydrocarbon production or cementing.

For a filtercake to form, the drilling fluid must contain some particles of a size only slightly smaller than the pore openings of the formation. These particles are known as bridging particles and are trapped in surface pores, thereby forming a bridge over the formation pores. Soluble solids are used within the filtercake as a bridging agent. Examples of these soluble solids include salt solids in a salt saturated solution when salt solids are chosen as well as finely ground calcium carbonate. The solids are purposely added to the drilling, workover, or completion fluids to form a filtercake that can later be partially dissolved by either aqueous or acidic flushes of the wellbore.

Filtercake building fluids can also contain polymers for suspension of solids within the filtercake and for reducing liquid loss through the filtercake by encapsulating the bridging particles. These can be either natural or synthetic polymers. The polymers may include a single polymer, such as xanthan, selected for its rheological properties combined with a second polymer, a starch for example, selected for the reduction of fluid loss in the wellbore.

At completion of the drilling or other well servicing, the filtercake must be removed to allow production in the formation or the bonding of cement to the formation at the completion stage. Removal of the deposited filtercake should be as complete as possible in order to recover maximum permeability within the formation and thus maximum oil and gas production.

Previous methods for removal of the filtercake from a wellbore utilized various types of solutions to dissolve the filtercake. Three commonly known methods include using an aqueous medium to dissolve sized salt, using an acid compound to dissolve the carbonate bridging agents in the filtercake, or using an oxidizing substance to decompose the polysaccharide polymer in the filtercake, thus breaking down the filtercake.

An acid removal solution for the dissolution of a filtercake is described in Hollenbeck et al., U.S. Pat. No. 4,809,783. Here the removal solution is comprised of fluoride ions, controlling the pH of the solution. The fluoride ions holding the pH of the removal solution between 2 and 4, the acid range. In some embodiments, an oxidizer and boric acid are added to the solution.

Another acid compound for filtercake removal is found in Mondshine et al., U.S. Pat. No. 5,238,065, which discloses a two step process and composition for removal of polymer-containing filtercakes from wellbores. First, the filtercake is contacted with a soak solution comprising aqueous brine, a peroxide and an acidic substance providing a pH from 1 to about 8, for a period of time sufficient to decompose the polysaccharide fibers of the filtercake. The mass created by this process is then contacted with a wash solution in which the bridging particles are soluble to remove the remaining filtercake solids. Lee, U.S. Patent App. No. 0040055747, discloses an acidic filtercake removal where a polymerized alpha-hydroxycarboxylic acid coated proppant, such as a sized industrial sand. The acid by-product generated from the hydration of polyglycolic-acid-coated sand can breakdown acid-soluble and acid-breakable components embedded in the filtercake.

Lee, U.S. Patent App. No. 0040055747, discloses an acidic filtercake removal where a polymerized alpha-hydroxycarboxylic acid coated proppant, such as a sized industrial sand. The acid by-product generated from the hydration of polyglycolic-acid-coated sand can breakdown acid-soluble and acid-breakable components embedded in the filtercake.

Yet another acid filtercake removal is found in Dobson et al, U.S. Pat. No. 5,783,527, where a well fluid which deposits a filtercake is disclosed. The fluid is comprised of a peroxide. The filtercake is also removable by contacting it with an acidic solution to activate the peroxide in the filtercake decomposing the polymers in the filtercake.

An oxidizing method for removing filtercake is found in Murphey et al., U.S. Pat. No. 6,143,698. The '698 patent discloses a method for removing filtercake by contacting the filtercake with a brine solution containing an oxidizer, specifically bromine or bromate generating agents, to degrade the polymers within the filtercake. The brine contains bromide salts and an oxidant capable of delayed oxidation of the bromide to bromine or bromate under downhole conditions.

Todd, U.S. patent application Ser. No. 09/756,961, also uses an oxidizing method that includes a fluid for depositing a filtercake. A bridging agent comprises a synthesized inorganic compound, which is dissolvable in an aqueous solution. The inorganic bridging agent is a bonded ceramic compound. The inorganic bridging agent is dissolvable in an aqueous solution. The aqueous solution used to dissolve the bridging agent contains a mild organic acid, a hydrolysable ester, an ammonium salt, a chelating agent or a mixture of ammonium salt and a chelating agent. The bridging agent may contain an oxidizer.

Dobson et. al., U.S. Pat. No. 5,607,905, disclose a process for removal of filtercake by depositing a peroxide within the filtercake. The filtercake is contacted with an acidic solution to activate the peroxide and dissolve the polymer.

An additional method of filtercake removal can be found in Weaver et al., U.S. Pat. No. 5,501,276. Weaver '276 discloses a method and composition for removal of filtercake from the walls of wellbores by using an aqueous sugar solution. The solution is comprised of water and sugar where the sugar is selected from a group consisting of monosaccharide sugars, disaccharide sugars, tri-saccharide sugars and mixtures thereof. Contact between the filtercake and this solution for an extended period of time causes disintegration of the filtercake. The fluid composition may also include a surface active agent for promoting the penetration of the drilling fluid and filtercake by the removal composition. The surface active agents are a blend of non-ionic ethoxylated alcohols or a mixture of aromatic sulfonates.

Brookey et al., U.S. Pat. No. 6,148,917, discloses a method to remove stuck pipe by using a spotting fluid to attack a mud filter cake. The spotting fluid comprises aphrons, which are a core of an internal phase, usually gas, surrounded by a thin shell of surfactant molecules. The spotting fluid also comprises a liquid, a viscosifier, an aphron generating surfactant and, optionally, a releasing agent.

Strong acids can promote corrosion in the well and lead to a non-uniform filtercake removal because of the rapid reaction rate with the carbonate bridging agent. A non-uniform removal tends to result in limited cake removal across the production interval. The remaining filtercake will restrict flow from the formation and limit oil and gas production from the well.

The use of oxidizing agents to degrade the polymeric portions of the cake also has limitations. Oxidizing agents can promote corrosion. Oxidizing agents also add new health, safety, and environmental issues to the project.

As a consequence of the limitations of the existing methods for removing a filtercake from the wellbore, there is a need for a method of removing filtercake that is safe, removes filtercake uniformly throughout the wellbore and does not promote corrosion.

### SUMMARY

In the method of this invention, a filtercake is removed from a subterranean borehole by de-functionalization of a downhole, water dispersible, polymeric material in the filtercake. As used in this description and the appended claims, the word de-functionalization means “to render non-functioning.” In other words, it reverses the sealing of the walls of the oil and gas formation.

The drilling of a wellbore often requires the temporary use of water-dispersible polymeric materials. Water-dispersible polymers are used in the makeup of filtercakes layered along the walls of a formation to prevent hydrocarbon leakage prior to the production stage. Water-dispersible polymers are also commonly used in fluid loss pills. Once these substances are no longer required, for example, when the well is ready to produce, the filtercake or fluid loss pills must be removed in a manner that is of least damage to the bore hole and the production formation. Removal of the deposited filtercake or fluid loss pills should be as complete as possible to increase flow in or out of the formation.

To accomplish removal of the deposited filtercake or fluid loss pills in accordance with the present method, a dehydrating agent is used to de-functionalize the downhole, water-dispersible, polymeric material after it is no longer useful in the well. This method may render the water-dispersible polymeric material non-functional without many of the ill effects of prior methods, such as premature leaking of fluids into the well bore. Contacting the filtercake or other downhole composition with a dehydrating agent de-functionalizes the filtercake by removing water molecules from the water dispersible polymeric structure to make the polymer no longer water dispersible.

When the polymeric material is dispersed in water, water molecules interact with the polymers through hydrogen bonding. Hydrogen bonding is defined as an attractive interaction of a hydrogen atom with an atom of relatively high electronegativity. This interaction is weaker than a covalent bond. When water is introduced to the polymeric material, the polymeric chains interact in response to this hydrogen bonding. These interacted chains operate with the bridging agent to seal the pores within the formation walls. By removing water from the polymeric material, the polymeric chains are no longer interacting. The disassociation of the polymeric chains, by the removal of water, is a physical change within the polymeric material. The molecular formula of the polymeric material remains the same, and no chemical change has occurred. Once the chains are no longer interactive, the polymeric material no longer binds the bridging agent and the pores of the formation walls are no longer sealed. Instead, the polymeric material is transformed to a non-dispersible material that may be easily swept away, which renders the polymeric material non-functional.

The water is removed from the polymeric material with a dehydrating agent. The use of a dehydrating agent to de-functionalize the polymer has several advantages over previously existing methods for filtercake removal. First, this method avoids the use of either strong acids or oxidizing agents to degrade the filtercake. It is an important improvement since these reagents promote corrosion of metals such as the metals used in casings within the wellbore. Unlike prior methods using strong acids or oxidizing agents, the method of the present invention allows a more controlled removal of the filtercake. The controlled de-functionalization of downhole polymers allows the filtercake to be removed at a slower and more uniform pace thereby avoiding spot breakthroughs of the filtercake lining the walls which results in premature spurts of formation fluid. Additionally, many formations comprise high quantities of clay. Clay swells when contacted with large volumes of water. The method of this invention minimizes the exposure of fresh water sensitive production zones, such as high clay formations, to large volumes of fresh water. Finally, economics often plays the deciding role in the choice of downhole materials. Materials, such as brine that can be recycled, are preferred. The method of this invention facilitates the reclamation of contaminated downhole fluids. Rendering the water-dispersible polymers non-functional leaves the polymers as non-dispersible material that is more easily separated from the brines than dispersed polymers.

In one embodiment for the controlled de-functionalization of downhole polymers, the method comprises contacting a downhole, water-dispersible polymeric material with a liquid comprising a dehydrating agent. The liquid does not comprise an oxidizing agent and is essentially free of a viscosifying agent. The method further comprises removing water from the water-dispersible polymeric material until the polymeric material is sufficiently de-functionalized to be removed from the liquid.

The water-dispersible polymeric material may comprise synthetic water dispersible polymers. The synthetic water-dispersible polymers may be selected from polyacrylamides, polyacrylates, polyvinyl alcohols or mixtures thereof. In another embodiment, the water-dispersible polymeric material may comprise natural water-dispersible polymers. The natural water-dispersible polymers may be selected from polysaccharides comprising xanthan, hydroxy celluloses, starches, guar gum, welan gum and mixtures thereof.

In one embodiment, the water-dispersible polymeric material may comprise fluid loss pills. In another embodiment, the water-dispersible polymeric material may comprise a filtercake. The filtercake may comprise synthetic water-dispersible polymers or natural water-dispersible polymers.

In one embodiment, the liquid comprising the dehydrating agent may be essentially free of an oxidizing agent, including any peroxides. In another embodiment, the liquid may be essentially free of additives. The liquid may also be free from aphrons, precursors for oxidizing agents, or acids comprising a H⁺ concentration of greater than 10⁻² M.

The dehydrating agent may have a water activity measurement below 0.6. In one embodiment, the dehydrating agent may comprise an organic liquid. The organic liquid may be selected from acid anhydrides, esters, alcohols, glycols, ethers, ketones, aldehydes, amides, organic acids and mixtures thereof.

In another embodiment, the dehydrating agent may comprise a concentrated salt solution. The salts within the salt solutions may comprise halides or salts of transitional metals. The salts may be selected from calcium bromide, zinc bromide, calcium chloride, zinc chloride, aluminum chloride, aluminum bromide, manganese chloride, manganese bromide, ferric chloride, formates and acetates of sodium, potassium and cesium, and mixtures thereof.

The salt solution may comprise an inorganic solvent. In another embodiment, the salt solution may comprise an organic solvent. This organic solvent may comprise acid anhydrides, esters, alcohols, glycols, ethers, ketones, aldehydes, amides, organic acids and mixtures thereof. In yet another embodiment, the salt solution may comprise a mixture of an inorganic and an organic solvent.

In one embodiment, the de-functionalization of the water-dispersible polymeric material may alter the physical state of the water-dispersible polymeric material without altering the chemical properties of the polymeric material.

In another embodiment, the method for the controlled de-functionalization of a filtercake may comprise: selecting a dehydrating agent, the dehydrating agent essentially free of a viscosifying agent and contacting a downhole, water-dispersible, polymeric material with a solution comprising the dehydrating agent, thereby altering the physical state of the polymeric material without altering the chemical properties of the polymeric material by removing water from the polymeric material. The dehydrating agent may comprise less than 2% of an oxidizing agent. In another embodiment, the dehydrating agent may not comprise an oxidizing agent.

The dehydrating agent may have a water activity measurement below 0.6. In one embodiment, the dehydrating agent may comprise an organic liquid. The organic liquid may be selected from acid anhydrides, esters, alcohols, glycols, ethers, ketones, aldehydes, amides, organic acids and mixtures thereof.

In another embodiment, the dehydrating agent may comprise a concentrated salt solution. The salt within the salt solution may comprise halides or salts of transitional metals. The salts may be selected from calcium bromide, zinc bromide, calcium chloride, zinc chloride, aluminum chloride, aluminum bromide, manganese chloride, manganese bromide, ferric chloride, formates and acetates of sodium, potassium and cesium, and mixtures thereof. In one embodiment, the salt solution may comprise an inorganic solvent. In another embodiment, the salt solution may comprise an organic solvent. This organic solvent may comprise acid anhydrides, esters, alcohols, glycols, ethers, ketones, aldehydes, amides, organic acids and mixtures thereof. In still another embodiment, the salt solution may comprise a mixture of an inorganic and an organic solvent.

In another embodiment, a method for the controlled de-functionalization of a downhole filtercake may comprise: contacting a downhole filtercake comprised of water-dispersible polymeric material with a dehydrating agent, the dehydrating agent comprising a mixture of an organic solvent and salts selected from calcium bromide, zinc bromide, calcium chloride, zinc chloride, aluminum chloride, aluminum bromide, magnesium chloride, manganese bromide, ferric chloride, formates and acetates of sodium, potassium and cesium and mixtures thereof. The resulting composition of the dehydrating agent and the filtercake does not comprise an oxidizing agent. It alters the physical state of the polymeric material without altering the chemical properties of the polymeric material by removing water from the polymeric material. In this embodiment, the resulting combination of the water-dispersible polymeric material and the dehydrating agent may be essentially free of a viscosifying agent.

In yet another embodiment, a method for the controlled de-functionalization of downhole fluid loss pills may comprise: selecting a dehydrating agent with a water activity level of 0.6 or less, contacting a water-dispersible polymeric material with the dehydrating agent, the dehydrating agent comprising concentrated salt solutions, thereby altering the physical state of the polymeric material without altering the chemical properties of the polymeric material by removing water from the polymeric material, and adding the dehydrating agent until the fluid loss pills are sufficiently de-functionalized to be removed.

### BRIEF DESCRIPTION OF THE DRAWINGS

FIG. 1 is a graphical representation of water activity versus concentration of salt solution in molarity.

FIG. 2 is a graphical representation of water activity versus concentration as salt solution in weight % of salt in the solution.

FIG. 3 is a graphical representation of water activity versus density of salt solution.

### DETAILED DESCRIPTION

The detailed description of this invention will be limited to the embodiment encompassing the de-functionalization of a filtercake and fluid loss pills. However, the method works just as efficiently to de-functionalize other downhole materials comprised of water dispersible polymers. In the method as described, filtercake formed on the walls of a subterranean borehole is removed by contacting the filtercake with a dehydrating agent for a period of time required to physically break down the filtercake so that production fluids flow. Filtercakes are typically formed with polymers that encapsulate particles or solids known as bridging agents which form a bridge over the pores of the formation.

Bridging agents within the drill-in fluid may be composed of water soluble, acid soluble or oil soluble materials. The filtercake comprises solid bridging agents. Solid bridging agents include calcium carbonate, silica flour, fibers, insoluble metal salts, insoluble metal oxides, insoluble metal hydroxides and mixtures thereof. If fibers are used, they are selected from insoluble polymers. Additional examples of the materials used for bridging agents include sized salt solids in salt saturated solutions, finely ground carbonates found in limestone, marble, or dolomite, insoluble carbonates of metals, metal oxides, metal hydroxides or oil soluble material such as resins, waxes and the like.

Once the filtercake is no longer required, typically prior to the operation stage of an oil or gas well, the filtercake is removed from the walls of the producing formation. To that effect, a dehydrating agent is sent down hole with compatible completion fluids for contact with the filtercake until it is sufficiently de-functionalized by dehydration of the polymer to be removed. The dehydrating fluids are selected for their characteristic of attracting water molecules from other compounds or mixtures.

Polymers that can form filtercakes or fluid loss pills may be either natural or synthetic in origin. Water-dispersible polymers that form filtercakes may possess a polar site at which water can interact with the polymer. This interaction permits the polymers to become dispersible in water, forming an interactive polymeric network. When this interactive polymeric network is formed, the water-dispersible polymer is functional for filtercake or fluid loss use.

In one embodiment, the polymers are selected from natural water-dispersible polymers. The natural water dispersible polymers typically comprise polysaccharides, for example complex carbohydrates of the sugar group. These polymers have polar oxygen or nitrogen sites at which the hydrogen atoms in water can associate. Other natural, water-dispersible polymers are such polysaccharides as xanthan, hydroxy celluloses such as hydroxyethyl cellulose, hydroxypropyl cellulose, dihydroxypropyl cellulose, cellulose ethers, including carboxymethylcellulose, methylcellulose, carboxymethyl cellulose, and their corresponding crosslinked derivatives; various kinds of modified starches including hydroxypropyl starch, hydroxyethyl starch, carboxymethyl starch, their corresponding crosslinked derivatives and their ethers and acetates; guar gum, and welan gum and mixtures thereof.

In another embodiment, the polymers are selected from synthetic polymers. Synthetic polymers include acrylic and certain vinyl polymers, for example, polyacrylamides, polyacrylates, and polyvinyl alcohols, which like the natural polymers have polar oxygen or nitrogen sites that can interact with water.

When the polymers are dispersed, water molecules interact with the polar sites of the polymeric chains and form a network. The introduction of the dehydrating agent attracts the water molecules away from the polymeric chains. As a result, the polymer chains may no longer interact with the water molecules. This causes the chains to separate because the water molecules are no longer interacting with the chains to produce a water-dispersible polymeric network. When this occurs, the polymeric material may transform from a gel-like dispersible substance into a thick mass or glob of non-dispersible substance permitting easy separation of the polymeric material from the solution thereby facilitating removal from the well.

Although the polymeric material changes from a gel-like dispersible substance to a thick mass or glob of non-dispersible substance, the polymeric material does not undergo a chemical change and its chemical structure remains unchanged. In addition, the polymeric material may not display a change in molecular weight, excluding the effect of any associated water (polymeric water of hydration) still present in the thick mass.

One indication or measurement of the dehydrating capacity of an agent used in this invention is its water activity measurement. Since filtercakes are tough, almost insoluble coatings, the dehydrating capacity of the agent must be effective enough so as to attract the water molecules within the polymer thereby causing the polymer chains to disassociate and thus no longer be interactive, forming a non-dispersible material. In one embodiment of this invention, the dehydrating agent may be selected from concentrated inorganic salt solutions, concentrated organic salt solutions, acid anhydrides, esters, alcohols, ethers, ketones, aldehydes, amides, organic acids and mixtures thereof. Other dehydrating agents, known in the art, can also be used, including various forms of foam-forming materials. The dehydrating capacity of these agents can be measured by its water activity.

Water activity of dehydrating agent solutions is a measurement of the “free water” as determined by water vapor or humidity above the solution. Because dehydrating agents bind water molecules, there is very little “free” water available. For example, many metal ions in brines have an affinity for water and bind water molecules. As a result, there is less “free water” available and the “water activity” decreases as the concentration of metal ions increases. The water activity is easily measured by an electrohygrometer which simply measures the amount of water in the vapor above the fluid. The water activity of the agent solutions is therefore a measurement of the “free water” as determined by the water vapor or humidity above the solution. An effective dehydrating agent for the de-functionalization of a filtercake or fluid loss pill has a water activity measurement of below 0.6.

As a generality, the greater the charge on the metal ion, the higher the affinity for water and the higher the number of water molecules that will be bound to the metal. This means that divalent ions, such as calcium or zinc will bind water more strongly than monovalent ions such as sodium or potassium. As a consequence, these solutions of the divalent ions have more affinity to attract water from their surroundings. Based on experimental data, activities for several concentrated brines are given in the Table below:

TABLE
Water Activities for Miscellaneous Brine Fluids

| Brine | Activity |
|---|---|
| 9.7 ppg NaCl | 0.81 |
| 10.0 ppg NaCl | 0.77 |
| 9.1 ppg CaCl₂ | 0.98 |
| 11.6 ppg CaCl₂ | 0.40 |
| 10.0 ppg CaBr₂ | 0.89 |
| 14.2 ppg CaBr₂ | 0.34 |
| 16.2 ppg ZnBr₂ | 0.33 |
| 19.2 ppg ZnBr₂ | 0.22 |

Certain generalizations can be applied to water activity. Based on molar equivalence, it has been determined that:

a. Activity decreases with increasing brine concentration

b. Activity is less with smaller ions (given equal concentrations)

c. Activity is less with divalent ions than with monovalent ions

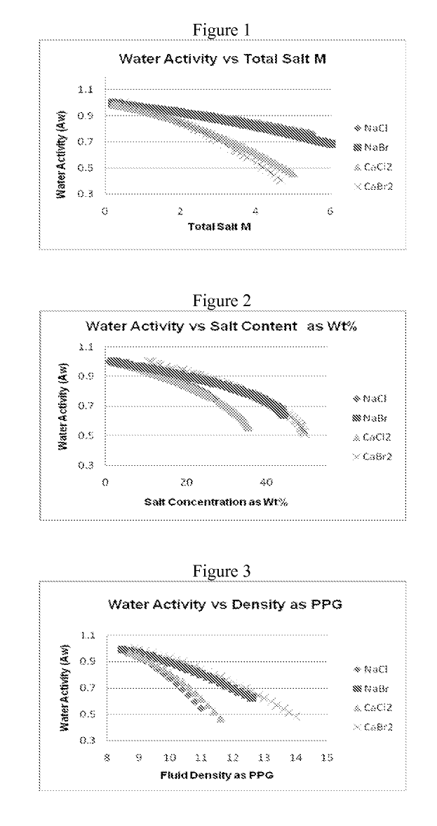

FIG. 1 is a graphical comparison of water activity versus the concentration in molarity of four salts, namely sodium chloride, sodium bromide, calcium chloride and calcium bromide. As shown in FIG. 1, an increase in the concentration of the salt results in a lower water activity level. As discussed above, water activity is the ability of the fluid to attract water. Because of a variation of the properties of the salt, two different salts of comparable molar concentration may attract water to different degrees and thus have different water activity values at the same concentration. However, in general, increasing salt concentration results in a lower water activity value for the same salt.

Referring to FIG. 2, water activity may not directly correlate to the weight percentage of the salt in the solution. For example, a 30% CaBr₂ solution has a water activity of 0.82 whereas a 23% CaCl₂ solution has a water activity of 0.81. If water activity always correlated with weight percentage of the salt solution, the CaBr₂ solution would have a lower water activity level than the CaCl₂ solution. However, because a 23% solution of CaCl₂ has a higher concentration in molarity than a 30% solution CaBr₂, these values are consistent with the generalization that activity decreases with increasing molar salt concentration.

Referring to FIG. 3, density may also not directly correlate with the water activity level. For example, as illustrated in Table 1, a 10.0 ppg solution of NaCl may have a water activity value of 0.77 whereas a 10.0 ppg solution of CaBr₂ may have a water activity value of 0.89. Therefore, the dehydrating agent may not be selected by the density alone.

Dehydrating agents are chosen for their water activity level as well as compatibility with other downhole chemicals. A wide range of dehydrating agents is available. In one embodiment, the dehydrating agent may comprise an organic liquid. The organic liquid can be selected from acid anhydrides, esters, alcohols, glycols, ethers, ketones, aldehydes, amides, organic acids and mixtures thereof. In another embodiment, the dehydrating agent consists essentially of an organic liquid. In yet another embodiment, the dehydrating agent may consist of an organic liquid.

In another embodiment, the dehydrating agent may comprise a salt solution, wherein the salt within the salt solution is an organic salt. The organic salt may comprise formates and acetates of sodium, potassium and cesium or mixtures thereof. The salt solution comprising an organic salt may further comprise either an organic or an inorganic solvent. The organic solvent may be selected from acid anhydrides, esters, alcohols, glycols, ethers, ketones, aldehydes, amides, organic acids and mixtures thereof. The inorganic solvent may comprise water. Alternatively, the organic salt solution may comprise a mixture of an organic and an inorganic solvent.

In still another embodiment, the dehydrating agent may comprise a salt solution, wherein the salt within the salt solution is an inorganic salt. Inorganic salts can include halides and salts of transitional metals. Salts may be selected from calcium bromide, zinc bromide, calcium chloride, zinc chloride, aluminum chloride, aluminum bromide, manganese chloride, zinc chloride, aluminum chloride, aluminum bromide, manganese chloride, manganese bromide, ferric chloride, and mixtures thereof. The salt solution comprising an inorganic salt may further comprise either an organic or an inorganic solvent. The organic solvent may be selected from acid anhydrides, esters, alcohols, glycols, ethers, ketones, aldehydes, amides, organic acids and mixtures thereof. The inorganic solvent may comprise water. Alternatively, the organic salt solution may comprise a mixture of an organic and an inorganic solvent.

When using an organic liquid, the liquid may serve two purposes. First, the liquid may be used as a solvent to dissolve a salt prior to introducing the solution downhole. The organic liquid also may also be a dehydrating agent itself and react with or bind water molecules.

Organic dehydrating agents may be selected from compounds that react with water, including anhydrides and dehydrating agents made from esters. Anhydrides include acetic anhydride, propionic anhydride, or any other anhydride known in the art, and mixtures thereof. Dehydrating agents made from esters include methyl formate, ethyl formate, methyl orthoformate, ethyl orthoformate as well as polyesters and cyclic esters. The dehydrating agent may also be selected from compounds that bind water, including alcohols such as methanol, ethanol, polyols, glycols, polyglycols, and the like.

The dehydrating agents may be essentially free of oxidizing agents. The presence of an oxidizing agent in the solution containing the dehydrating agent may degrade the polymeric material within the filter cake. Here, the oxidizing agent may chemically alter the structure of the polymeric material, resulting in a chemical change to the polymeric material in contrast to the dehydrating agents of the application which produce a physical change.

In one embodiment of the present invention, the dehydrating agent solution may be essentially free of an oxidizing agent. Essentially free may include only a trace amount of oxidizing agent. This trace amount may be introduced into the solution by accident. The solution may comprise less than 2% oxidizing agent. In another embodiment, the dehydrating agent solution may not comprise an oxidizing agent. In yet another embodiment, the dehydrating agent is free of peroxides.

The solution may also be free of precursors to oxidizing agents. Here, the combination of the dehydrating agent solution as well as the dehydrating agent will not yield an oxidizing agent. In one embodiment, the solution may be free of bromine or bromate generating agents.

When a polymeric material is contacted or reacted with an oxidizing agent, a chemical change occurs in the polymeric material. This chemical change includes a variation of the chemical structure of the polymeric material. For example, the polymer chain may be broken into smaller chains of lower molecular weight or monomers. This chemical change in the polymeric material occurs even when the solution comprises a small concentration of oxidizing agent. For example, a 2% solution of oxidizing agent can significantly change the chemical properties of the polymeric material. Also, contacting the polymeric material with a highly reactive chemical, for example a peroxide, also an oxidizing agent, can significantly degrade the polymeric material even if a small concentration of the chemical is reacted with the polymeric material.

In contrast, the present invention does not use an oxidizing agent in the de-functionalization of the polymeric material. As discussed above, the de-functionalization of the polymeric material is a result of a physical change. In one embodiment, the de-functionalization is a result of a purely physical change, and no chemical change occurs within the polymeric material.

In addition to lacking oxidizing agents, the solution comprising the dehydrating agent may also be free of other additives. In one embodiment, the solution is essentially free or preferably totally free of aphrons. In another embodiment, the solution does not comprise viscosifiers. In yet another embodiment, the solution may not comprise acids that contain a concentration of H′ that is greater than 10⁻² M.

In one embodiment, the water-dispersible polymeric material may comprise a filtercake (or fluid loss material) typically having bridging agents which form the wall of the filtercake. As the dehydrating agent removes the water molecule from the water-dispersible polymer, the polymer becomes ineffective and transformed into a non-dispersible material within the completion fluid that can be flushed out of the well bore. Some water soluble or water dispersible bridging agents will also be affected by the dehydrating agent and break apart. This occurs when the water molecules associated with the polymer molecules are attracted to the dehydrating agent. At that point, the polymer molecules are no longer strongly associated or interactive with the bridging agent. In some embodiments of this invention, especially useful for filtercakes having acid soluble, water-insoluble bridging agents, the selected dehydrating agent generates a mild to weak acid that can attack and disperse or dissolve the bridging agent. Acids are referred to as strong or weak according to the concentration of the H+ ion that results from ionization. Lewis, Richard J., Sr., Hawley's Condensed Chemical Dictionary, thirteen edition, p. 14.

Applicant defines a mild acid as one having a H⁺ ion concentration that is less than 10⁻² M. These bridging agents are degraded by the mild acid generated during the dehydration of the polymers. For example, if the known bridging agent is calcium carbonate and the dehydrating agent is acetic anhydride, the acid generated that degrades the bridging agent is acetic acid.

As in many industrial processes, the drilling of oil and gas wells results in contaminated by-products. Any downhole fluids such as brine that can be recycled are often preferred. The method of this invention facilitates the reclamation of contaminated downhole fluids. In one embodiment of this invention, rendering the water-dispersible polymers non-functional leaves the polymers as non-water dispersible material that is more easily separated from the brines than dissolved or dispersed polymers thereby allowing the brine to be reused.

In an alternative method for the controlled de-functionalization of water-dispersible polymers, the polymers are used in the formulation of downhole fluid loss pills. The fluid loss pills are contacted with a dehydrating agent that is mixed with a drilling or completion fluid. As the dehydrating agent contacts the fluid loss pills, water molecules are attracted to the dehydrating agent causing the break up of the fluid loss pills. In one embodiment of this invention, the dehydrating agent is selected from concentrated inorganic salt solutions, concentrated organic salt solutions, acid anhydrides, esters, alcohols, ethers, ketones, aldehydes, amides, organic acids and mixtures thereof. Other dehydrating agents known in the art can also be used, including various forms of foam-forming materials. The dehydrating agent is added downhole until the fluid loss pills are sufficiently de-functionalized to be removed.

The method of this invention is considered a controlled treatment of downhole polymers that results in making the polymers that make up the filtercake, fluid loss pills or other temporary downhole products non-functional. It is controlled because the de-functionalization of the polymers is a slow process. Because the process is controlled, the breakdown of the filtercake wall lining the production cavity is relatively uniform so that the formation wall is restored to its natural permeability to allow for hydrocarbon production.

### TEST EXAMPLES

### Examples

The following examples illustrate the performance of some dehydration additives that can be used in the de-functionalization of hydrated polymers with different water based fluids at relatively low temperature. The Tables also illustrate the range of dehydration rates of filter cakes containing hydrated polymers using the methodology of the invention. The break time is the time in which the filter cake is sufficiently de-functionalized such that the measured fluid loss is dramatically, almost exponentially, increased. In these examples, the break time is a reflection of rate of the de-functionalization of the polymer. A rapid or shorter break time indicates that the dehydrating agent is more effective in breaking up the polymers by removing the water molecule from water-dispersible polymers and therefore more effective in the de-functionalization of the filtercake. The break time can be controlled by varying the concentration of the additive as well as the combination of additives used during the procedure. In a laboratory, break time can also be controlled by varying the temperature. As used in the oil field a controlled de-functionalization of downhole polymers is accomplished by selection of the dehydrating agents and concentration of agents used in the breaker fluids. The controlled de-functionalization allows the filtercake to be removed at a slower and more uniform pace thereby avoiding spot breakthroughs of the filtercake lining the walls which results in premature spurts of formation fluid. The test examples reveal the principle of the invention as well as the importance of the conditions (concentration and identity of dehydrating agents, etc.) on its application and effectiveness. The results of the test examples are illustrated in Table-2 below.

### Test Examples 1-3

These examples show the importance of the concentration of the organic dehydrating agent. In examples 1 & 2 with only 25% of methanol or acetic anhydride at 160° F., no facile break down of the cake is observed. However, with a mixture of the two (total concentration of 50%, example 3), break down is relatively facile with a break time of 48 hrs.

### Test Example 4

In example 4, another dehydrating agent (ethyl orthoformate) is shown to be effective at the 25% level at the same temperature, illustrating the importance of the identity of the agent. Some agents can be more effective in certain instances than others. The orthoformate can act not only as a polymer de-functionalizer/dehydrator but concomitantly it can react with water to form an acid that degrades the calcium carbonate that further breaks down the filtercake.

### Test Example 5

Example 5 illustrates the effectiveness of a temperature increase. Despite a reduction in the concentration of the organic de-functionalizing additives from 50% total to 30% total, the break time is reduced dramatically (from 48 hr to 4 hr). Although less dramatic, similar reductions in break time with an increase in temperature are observed for examples 6 & 7, and 8 & 9.

### Test Examples 6-11

The effectiveness of the concentration of the organic de-functionalizing agent is most dramatically illustrated with these examples using 100% of the organic de-functionalizing agent. The importance of the balance of several factors is revealed by the slightly longer break times associated with the organic species that slowly liberate a mild acid in concert with the de-functionalization of the polymer (e.g., examples 8 & 9, or 10 versus examples 6 & 7). As mentioned above, the anticipated effect of temperature is illustrated by the examples 6-9 as well.

Table-1 below gives one of the filtercake formulations containing the hydrated polymers. The fluid which is CaBr₂/NaBr based has a specific gravity (SG) of 1.62.

TABLE 1
Filtercake Forming Fluid Containing Hydrated Polymers

| Component | Grams/Liter |
|---|---|
| CaBr₂ Brine (SG = 1.70) | 795.4 |
| NaBr Brine (SG = 1.50) | 704.0 |
| Starch | 13.7 |
| Sodium Thiosulfate | 0.7 |
| Magnesium Oxide | 2.9 |
| Xanthan Biopolymer | 3.4 |
| Sized Marble # 1 (3 μm to 400 μm) | 42.9 |
| Sized Marble # 2 (1 μm to 36 μm) | 42.9 |
| Proprietary Shale Stabilizer | 30.9 |

### Filtercake Forming Fluid Composition:

The CaBr₂ and NaBr brines are a stock commercial product marketed by TETRA Technologies, Inc. The starch used is commercially available from TETRA Technologies, Inc. The sodium thiosulfate and magnesium oxide were USP grade. The xanthan biopolymer and cationic starch are commercially available from several suppliers as well as from TETRA Technologies, Inc. under the trade names TETRA BioPol™ and TETRA PayZone® HPS. The sized marble powders are available from TETRA Technologies, Inc. under the trade names TETRA PayZone® Carb-Prime and TETRA PayZone® Carb-Ultra, respectively. The shale stabilizer is available from TETRA Technologies, Inc. under the trade name StrataFix™.

### Filtercake Removal Fluid:

The filtercake removal fluid for the tests below was a solution of the dehydration agent, which was used from 0 to 100% by vol. in a mixture of zinc bromide brine (SG=1.68 g/ml). Break time was controlled by varying the dehydrating agents, the concentration of agents and temperature as given in Table-2.

### Experimental Procedures:

The following mixing procedure was followed for all drilling fluid preparations. The formulation was prepared by mixing the components in the order as written in the Table-1. After the starch was added, before addition of the next components, the mixture was sheared with a high-shear mixer (Silversen type) for 30 seconds. Then the mixing was continued at 500 RPM using a low-shear Servodyne unit for 30 minutes. This shearing process was intended to simulate commercial mixing with a high shear centrifugal pump. The remaining chemicals were added followed by 30 minutes of mixing. Total mixing time was 60 minutes.

### Rheological Properties:

Rheological properties were measured at 120° F. After formulation of the fluid, the samples were “hot-rolled” at 160° F. in a roller oven for 17 hours. After the ‘hot rolling’, the rheological properties were again measured at 120° F. The samples were then used for “filter cake preparation and removal”.

### Filter Cake Preparation:

A filter cake was prepared using a standard high temperature and high pressure cell (HTHP cell) with a 5 μm (2000 mD permeability) ceramic disk as the filtering medium. Filter cake preparation was run at test temperature over 17 hours, with a squeeze pressure of 2100 KPa applied to the fluid. The filtrate was collected during this time and measured. A filter cake was produced that had an initial spurt fluid loss as the filter cake was building, but then had a rapid decline as the filter cake limited further fluid loss. At the end of the cake building time (17 hrs), the cell was cooled and the pressure released. The remaining fluid was drained from the cell and the filter cake was examined visually for uniformity.

### Filtercake Removal Fluid (Containing Dehydrating Agent) Testing

To a uniform filter cake in the HPHT cell, a breaker fluid mixed with various dehydrating agents was added (The fluid specific gravity was adjusted to a 1.68 S.G. with CaBr₂/NaBr brine). The cell was then pressurized (usually 55 to 700 KPa); temperature was adjusted, and time was monitored. After the breaker fluid had broken through the filter cake, the final break time was recorded. Test data for various additives and temperatures are given in Table-2.

TABLE 2
Filter Cake Removal by Miscellaneous Dehydrating Agents

| Ex | Agent | Break Time | | Temperature ° F. |
|---|---|---|---|---|
| 1 | ZnBr₂/25% Methanol | None | | 160 |
| 2 | ZnBr₂/25% Acetic Anhydride | None | | 160 |
| 3 | ZnBr₂/25% Methanol; | 48 | hours | 160 |
| | 25% Acetic Anhydride | | | |
| 4 | ZnBr₂/25% Ethyl Orthoformate | 90 | hours | 160 |
| 5 | ZnBr₂/20% Acetic Anhydride; | 4 | hours | 200 |
| | 10% Methanol | | | |
| 6 | 100% Methanol | 70 | minute | 140 |
| 7 | 100% Methanol | 40 | minute | 200 |
| 8 | 100% Acetic Anhydride | 80 | minute | 130 |
| 9 | 100% Acetic Anhydride | 54 | minute | 200 |
| 10 | 100% Ethyl Orthoformate | 75 | minute | 200 |
| 11 | 50% Acetic Anhydride; 50% | 95 | minute | 200 |
| | Methanol | | | |

The foregoing description is illustrative and explanatory of some embodiments of the invention, and variations in the size, shape, materials and other details will become apparent to those skilled in the art. It is intended that all such variations and modifications which fall within the scope or spirit of the appended claims be embraced thereby.

1. A method for the controlled de-functionalization of downhole polymers, the method comprising:
contacting downhole, water-dispersible, polymeric material with a liquid comprising a dehydrating agent, wherein the liquid does not comprise an oxidizing agent and is essentially free of a viscosifying agent; and
removing water from the water-dispersible polymeric material until the polymeric material is sufficiently de-functionalized to be removed from the liquid.

2. The method of claim 1, wherein the water-dispersible polymeric material comprises synthetic water dispersible polymers.

3. The method of claim 2 wherein the synthetic water dispersible polymers are selected from polyacrylamides, polyacrylates, polyvinyl alcohols or mixtures thereof.

4. The method of claim 1, wherein the water-dispersible polymeric material comprises natural water dispersible polymers.

5. The method of claim 4, wherein the natural water dispersible polymers are selected from polysaccharides comprising xanthan, hydroxy celluloses, starches, guar gum, welan gum and mixtures thereof.

6. The method of claim 1, wherein the water-dispersible polymeric material comprises fluid loss pills.

7. The method of claim 1, wherein the water-dispersible polymeric material comprises a filtercake.

8. The method of claim 7, wherein the filtercake comprises synthetic water-dispersible polymers.

9. The method of claim 7, wherein the filtercake comprises natural water-dispersible polymers.

10. The method of claim 1, wherein the oxidizing agent comprises peroxides.

11. The method of claim 1, wherein the liquid is essentially free of additives.

12. The method of claim 1, wherein the liquid is essentially free of aphrons.

13. The method of claim 1, wherein the liquid is essentially free of precursors for oxidizing agents.

14. The method of claim 1, where in the liquid is essentially free of acids comprising a H⁺ concentration of greater than 10⁻² M.

15. The method of claim 1, wherein the dehydrating agent has a water activity measurement below 0.6.

16. The method of claim 1, wherein the dehydrating agent comprises an organic liquid.

17. The method of claim 16, wherein the organic liquid is selected from acid anhydrides, esters, alcohols, glycols, ethers, ketones, aldehydes, amides, organic acids and mixtures thereof.

18. The method of claim 1, wherein the dehydrating agent comprises a concentrated salt solution.

19. The method of claim 18, wherein salts within the salt solution comprises halides.

20. The method of claim 18, wherein salts within the salt solution comprises transitional metals.

21. The method of claim 18, wherein the salts comprise salts selected from calcium bromide, zinc bromide, calcium chloride, zinc chloride, aluminum chloride, aluminum bromide, manganese chloride, manganese bromide, ferric chloride, formates and acetates of sodium, potassium and cesium, and mixtures thereof.

22. The method of claim 18, wherein the salt solution comprises an inorganic solvent.

23. The method of claim 18, wherein the salt solution comprises an organic solvent.

24. The method of claim 23, wherein the organic solvent is selected from acid anhydrides, esters, alcohols, glycols, ethers, ketones, aldehydes, amides, organic acids and mixtures thereof.

25. The method of claim 18, wherein the salt solution comprises a mixture of an inorganic and an organic solvent.

26. The method of claim 1, further comprising altering the physical state of the water-dispersible polymeric material without altering the chemical properties of the polymeric material.

27. A method for the controlled de-functionalization of a filtercake, the method comprising:
selecting a dehydrating agent, the dehydrating agent essentially free of a viscosifying agent; and
contacting a downhole, water-dispersible, polymeric material with a liquid comprising the dehydrating agent,
thereby altering the physical state of the polymeric material without altering the chemical properties of the polymeric material by removing water from the polymeric material.

28. The method of claim 27, wherein the dehydrating agent comprises less than 2% of an oxidizing agent.

29. The method of claim 27, wherein the dehydrating agent does not comprise an oxidizing agent.

30. The method of claim 27, wherein the dehydrating agent comprises a water activity level of 0.6 or less.

31. The method of claim 27, wherein the dehydrating agent comprises an organic liquid.

32. The method of claim 31, wherein the organic liquid is selected from acid anhydrides, esters, alcohols, glycols, ethers, ketones, aldehydes, amides, organic acids and mixtures thereof.

33. The method of claim 27, wherein the dehydrating agent comprises a concentrated salt solution.

34. The method of claim 33, wherein a salt within the concentrated salt solution comprises a salt selected from calcium bromide, zinc bromide, calcium chloride, zinc chloride, aluminum chloride, aluminum bromide, manganese chloride, manganese bromide, ferric chloride, formates and acetates of sodium, potassium and cesium, and mixtures thereof.

35. The method of claim 33, wherein the concentrated salt solution comprises an inorganic solvent.

36. The method of claim 33, wherein the salt solution comprises an organic solvent.

37. The method of 36, wherein the organic solvent comprises acid anhydrides, esters, alcohols, glycols, ethers, ketones, aldehydes, amides, organic acids and mixtures thereof.

38. The method of claim 33, wherein the salt solution comprises a mixture of an inorganic and an organic solvent.

39. A method for the controlled de-functionalization of a downhole filtercake, the method comprising:
contacting a downhole filtercake comprised of water-dispersible polymeric material with a dehydrating agent, the dehydrating agent comprising a mixture of an organic solvent and salts selected from calcium bromide, zinc bromide, calcium chloride, zinc chloride, aluminum chloride, aluminum bromide, magnesium chloride, manganese bromide, ferric chloride, formates and acetates of sodium, potassium and cesium and mixtures thereof, wherein the resulting composition of the dehydrating agent and the filtercake does not comprise an oxidizing agent; and
altering the physical state of the polymeric material without altering the chemical properties of the polymeric material by removing water from the polymeric material.

40. The method of claim 39, wherein the resulting combination of the water-dispersible polymeric material and the dehydrating agent is essentially free of viscosifying agent.

41. A method for the controlled de-functionalization of downhole fluid loss pills comprising:
selecting a dehydrating agent, the dehydrating agent essentially free of a viscosifying agent;
contacting a water-dispersible polymeric material with the dehydrating agent, the dehydrating agent comprising concentrated salt solutions,
thereby altering the physical state of the polymeric material without altering the chemical properties of the polymeric material by removing water from the polymeric material; and
adding the dehydrating agent until the fluid loss pills are sufficiently de-functionalized to be removed.
